(19) United States
(12) Patent Application Publication
(10) Pub. No.: US 2016/0245020 A1
(43) Pub. Date: Aug. 25, 2016

(54) LADDER EXTENSION BRAKING SYSTEM

(71) Applicant: Philip F. Lanzafame, Paulsbo, WA (US)

(72) Inventor: Philip F. Lanzafame, Paulsbo, WA (US)

(21) Appl. No.: 14/979,480

(22) Filed: Dec. 27, 2015

Related U.S. Application Data
(60) Provisional application No. 62/118,622, filed on Feb. 20, 2015.
(60) Provisional application No. 62/179,951, filed on May 26, 2015.

(51) Int. Cl. E06C 7/50; E06C 1/12

(52) U.S. Cl. CPC E06C 7/50; E06C 1/12

(57) ABSTRACT

A ladder extension braking system, for use on extension ladders with an adjustment rope for adjusting one or more sliding extension ladder sections, activated by releasing the rope and de-activated by pulling on the rope. The brake works at any point in the relative positions of the sections.

### BACKGROUND

Extension ladders have at least one telescoping, fly extension section that slides relative to the base (main) section of a ladder to gain additional length, or height which is adjusted by pulling on a rope. In many cases, when using the rope, it can slip from the user's hand, thereby releasing the fly or telescoping section accidentally, causing the fly or telescoping extension section to slide uncontrollably downward, potentially causing serious injury to the user's arm, hand, knee or other parts of the body. Additionally, ladder rails will typically slide apart from each other, or unlock at the rung-locks, when the ladder is set down, dropped, moved, bumped, transported, carried or when the base section slides out and away from a structure supporting the top of the ladder.

Locks are known which prevent the two or more sections from sliding relative to each other when the ladder is fully retracted. The locks cannot be engaged at any point in the travel of the sections relative to each other.

### SUMMARY OF THE INVENTION

This invention is designed to automatically stop or slow the telescoping, fly extension section of a ladder relative to the base (main) section of a ladder where the ladder has two or more sections that move against or in relation to each other to gain additional length, or height. This braking system is activated by releasing the rope or cable that is typically pulled to extend the fly or telescoping extension section of the ladder. It is de-activated by pulling on the rope or cable which is typically used for adjusting the fly sections of a ladder.

There are various types of prior art that address the locking or stopping of a ladder rail, but this invention is a new and innovative way to deal with accidental or unintentional sliding of the rails, whereby the most common of elements in most extension ladders (adjustment rope and pulley) are used to automatically provide safety and convenience for the ladder user that has never before been utilized.

The invention revolves around simple concepts. If there is less than about ¼ pound of tension on the rope that is used to adjust the fly section up or down, then the braking system is automatically activated by a spring loaded device that works together with the standard rope, with one or more cams or brakes that grab the rope or with one or more cams or brakes that grab the rails. The cams release the rope or rails as soon as about ¼ pound or more of tension is applied to the rope.

The invention can be utilized to automatically slow or stop the rails from sliding in only one direction (downward), or can be utilized to slow or stop the rails from sliding in both directions. A system designed to slow or stop the rails from sliding in both directions is more costly but offers additional safety benefits.

The invention can work manually or automatically by way of pulling the adjustment rope or cable in the designed direction, which may be downward, sideways, diagonally or any other direction. The adjustment rope or cable is connected to a pulley, or pulleys, which then releases the rope or the cams that are wedged against one of the ladder rails, thereby enabling the rails to slide in a normal, free fashion relative to each other. The rope or cable that moves the fly section up and down can attach to a rotating cam brake, or rung brake, or other type of spring loaded brake, thereby enabling the user to normally raise and lower the fly or telescoping extension section of the ladder when the rope or cable is not being pulled.

If the rope is accidentally released, with the cam brake, the spring loaded end of the rope allows the braking mechanism to engage automatically and brake the ladder rails so they cannot move any further up or down relative to the other rails.

The ladder brake is automatically set as soon as the rope is loosened or released by a person's hand, foot or other method of pulling a rope, rod or cable. The spring loaded mechanism activates the brake when loosened. When pulled, the spring loaded end enables release of the braking system mechanism.

In one aspect, the invention is a ladder extension braking system, for use on extension ladders with an adjustment rope for adjusting the extension, comprising a main ladder section having a foot in a downward direction and a top in an upward direction, an extension ladder section slidably engaged to the main ladder section to allow sliding relative to the main ladder section to extend upwardly above the top of the main ladder section when an adjustment rope is pulled, a brake base that holds brake components, coupled to the brake base, a downward brake, biased by a downward brake spring into engaged position that restrains the extension ladder section against downward movement relative to the main ladder section, and a downward brake retractor, activated to overcome the bias of the downward brake spring by tension applied to the adjustment rope, thereby releasing the brake and allowing the extension ladder section to slide relative to the main ladder section.

The brake base may be mounted on the extension ladder section or on the main ladder section. The brake retractor may be coupled to the adjustment rope such that, when tension is applied to the rope, the brake is retracted. The brake retractor may be coupled to a pulley at the top of the main ladder section which pulley moves downwardly relative to the main ladder section when tension is applied to the adjustment rope, thereby retracting the brake.

The brake base may be coupled to a pulley at the top of the main ladder section around which the adjustment rope runs, in which case the brake acts on the adjustment rope to restrain the extension ladder section against downward movement relative to the main ladder section, and the brake retractor releases the adjustment rope when tension is applied to the adjustment rope.

In another aspect the invention is a ladder extension braking system, for use on extension ladders with an adjustment rope for adjusting the extension, where the brake works at any adjustment of the extension, comprising: a main ladder section having a foot in a downward direction and a top in an upward direction, an extension ladder section slidably engaged to the main ladder section to allow sliding relative to the main ladder section to extend upwardly above the top of the main ladder section when an adjustment rope is pulled, a brake base which holds brake components, coupled to the brake base, an upward brake, biased by an upward brake spring into engaged position that restrains the extension ladder section against upward movement relative to the main ladder section at any relative position between the main ladder section and the extension ladder section, and an upward brake retractor, activated to overcome the bias of the upward brake spring by tension applied to the adjustment rope, thereby releasing the brake and allowing the extension ladder section to slide relative to the main ladder section.

The brake base may be mounted on the extension ladder section or on the main ladder section. The brake retractor may be coupled to the adjustment rope such that, when tension is applied to the rope, the brake is retracted. The brake retractor may be coupled to a pulley at the top of the main ladder section which pulley moves downwardly relative to the main ladder section when tension is applied to the adjustment rope, thereby retracting the brake.

In another aspect, the invention is a ladder extension braking system, for use on extension ladders with an adjustment rope for adjusting the extension, comprising: a main ladder section having a foot in a downward direction and a top in an upward direction, an extension ladder section slidably engaged to the main ladder section to allow sliding relative to the main ladder section to extend upwardly above the top of the main ladder section when an adjustment rope is pulled, a brake base, coupled to the brake base, an upward brake, biased by an upward brake spring into engaged position that restrains the extension ladder section against upward movement relative to the main ladder section, an upward brake retractor, activated to overcome the bias of the upward brake spring by tension applied to the adjustment rope, thereby releasing the brake and allowing the extension ladder section to slide relative to the main ladder section, coupled to the brake base, a downward brake, biased by a downward brake spring into engaged position that restrains the extension ladder section against downward movement relative to the main ladder section, and a downward brake retractor, activated to overcome the bias of the downward brake spring by tension applied to the adjustment rope, thereby releasing the brake and allowing the extension ladder section to slide relative to the main ladder section.

The downward brake retractor and the upward brake retractor may be combined in a single structure. The downward brake spring and the upward brake spring may be combined in a single spring. The downward brake and the upward brake may be combined in a single structure.

The brake base may be mounted on the extension ladder section or the main ladder section. The brake retractor may be coupled to the adjustment rope such that, when tension is applied to the rope, the brake is retracted. The brake retractor may be coupled to a pulley at the top of the main ladder section which pulley moves downwardly relative to the main ladder section when tension is applied to the adjustment rope, thereby retracting the brake.

### BRIEF DESCRIPTION OF THE DRAWINGS

FIG. 1 shows all components of the system.

FIG. 2 shows details of an example of the brake components.

### DETAILED DESCRIPTION

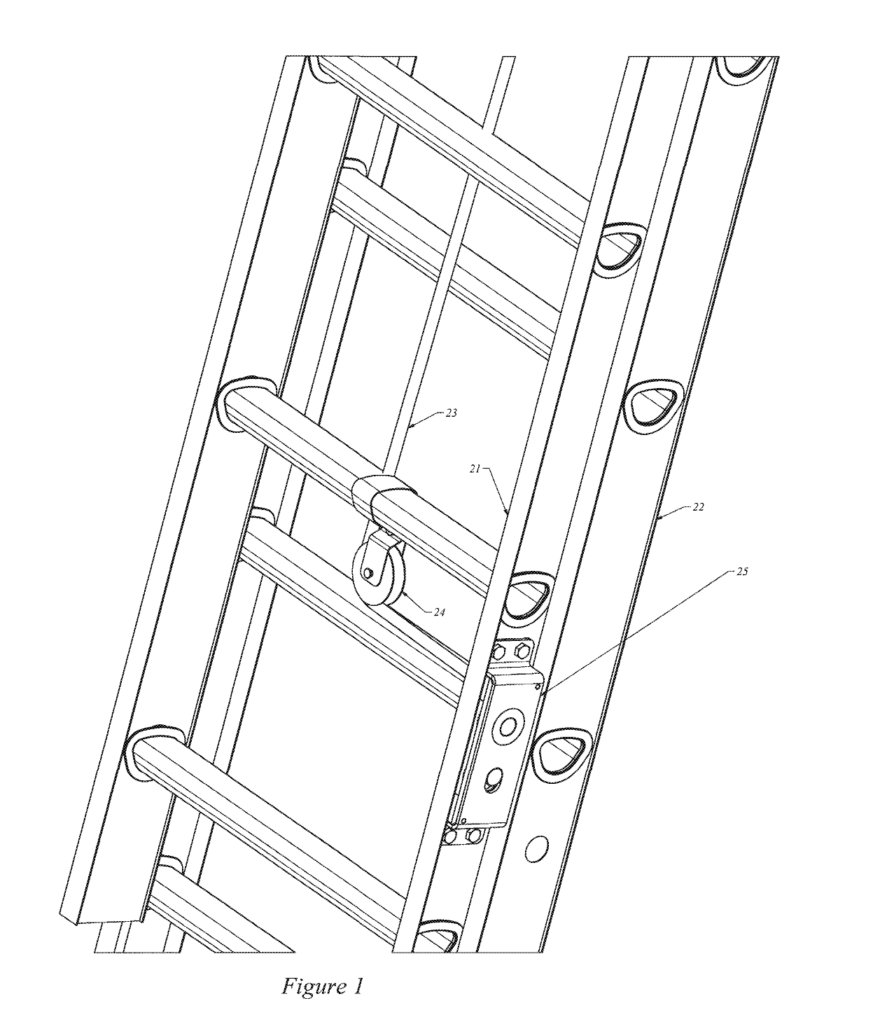

FIG. 1 shows all components of the system: the main ladder section 22, the fly or extension ladder section 21, the extension adjustment rope 23, a rope force direction changing component 24 (in this case a pulley) and the brake assembly 25. The brake assembly is shown mounted on the fly section. It can instead by mounted on the main section. This system works whether the ladder is designed with the extension (“fly”) section closer to the wall or farther from the wall than the main ladder section.

The proper method to operate the brake assembly is to pull on the loose, hanging end of the rope, which releases the brake. Releasing (letting go of) the rope automatically activates the brake.

The rope force direction changing component 24 is shown mounted near the bottom of the extension section. If the brake is mounted on the top of the main section, the rope force direction changing component would be coupled to a pulley at the top of the main section. When the rope is pulled, the pulley is pulled downward and the rope force direction changing component retracts the brake retractor.

The rope force direction changing component 24 may be a pulley as shown, or a tube that bends 90 degrees, or a lever, or any mechanism that releases the brake when force is applied to the rope.

A particular way to make this component when the brake is mounted at the bottom of the fly section is to drill a small hole (⅛″ dia.) in the top of the lowest rung on the fly section, just large enough for a cable to pass through. The rope can hook onto the cable above the rung hole. The cable can attach to a lever inside the rung that operates the brake retractor.

Alternatively, there can be a slow 90 degree turn, made of 3/16″ diameter aluminum tube, inside the hollow part of the rung which travels all the way to the rail. The aluminum tube would essentially be L shaped with a threaded portion at the end which allows the end of the L to attach with a small nut to the hole on the top of the ladder rung.

Another option, to avoid drilling a hole in the rung, is to have a metal or composite tube or sleeve that starts on the back side of the same rung and spirals around the rung from top of the rung to bottom of rung and from the center of the rung to one end of the rung to the side rail. The rope or cable can be inside this sleeve all the way to the brake assembly.

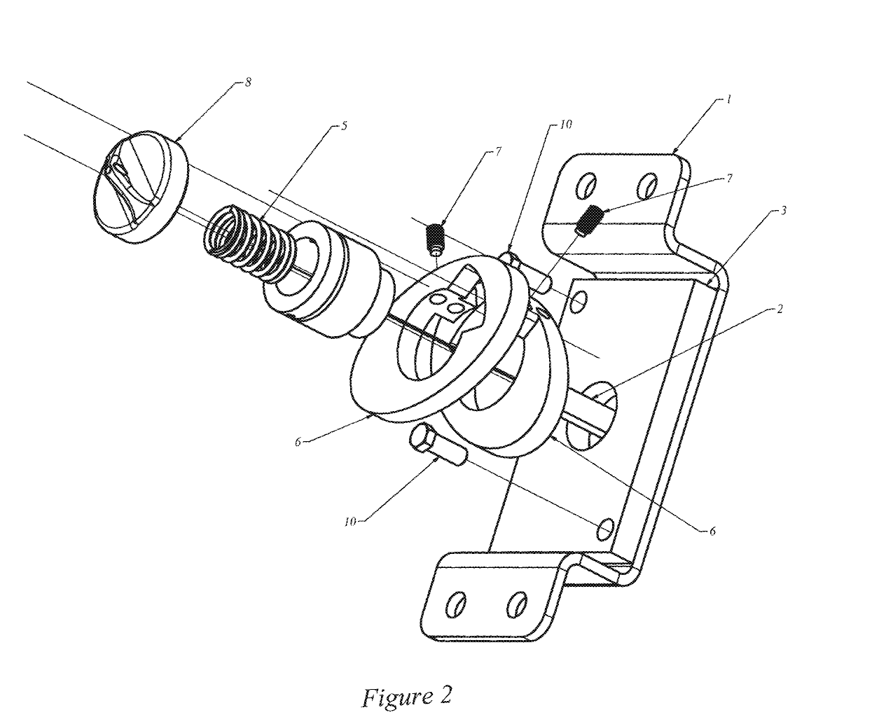

Components of a typical brake assembly are shown in FIG. 2. A preferred way to make the brake is to use a “leading” cam, in contrast to a “trailing” cam, which means that the cam is configured so that sliding motion to be opposed by the brake causes the brake to be more engaged rather than tending to release the brake. Such a cam is more engaged by sliding in only one direction. If sliding in both directions is to be opposed by the braking system, two leading cams are required, one for each direction.

Alternatively, a single brake structure may be used which is neutral, neither leading nor trailing, or which, when pulled in either direction by sliding friction, wedges against one of two inclined planes affixed to the brake base, in which case a single brake structure can act as a “leading” wedge to stop motion in both directions.

FIG. 2 shows two cams 6. A spring 5 urges each cam into engagement with the rail of the main ladder section 22 until force is applied via the rope, or a cable coupled to the rope, to the brake retractor 8 which retracts the cams. Instead of using a single spring, a separate spring could be used for each cam. Instead of using a single brake retractor, a separate retractor could be used for each cam.

In the design of FIG. 2, force applied to either cam by the rail of a ladder section is passed to the brake base 1 which is mounted on the other section. The brake assembly shown in FIG. 2 can be mounted on either ladder section to apply braking against the rail of the other section. Each cam has two lobes. The lobes protrude beyond the edge of the base 1 to engage the rail of a ladder section. Because the lobes protrude beyond the edge of the base 1 on both sides of the base, the brake assembly can be mounted with either side against the rail of a ladder section.

Also shown in FIG. 2, each cam 6 has a setscrew 7 that protrudes into a groove in an actuator 4 that is acted upon by the spring 5. Force is carried from the cams 6 to the actuator 4 to a plate 3 to bolts or rivets 10 to the base 1.

What is disclosed is an automatic, secondary, back-up, braking system that instantly slows or stops a fly section ladder rail, regardless of its position relative to the main section, from moving downward or upward when the rope used to adjust the fly section up or down is released. The brake is retracted when a minimum of about ¼ pound of tension is applied to the rope that is used to adjust the fly section up or down.

Another embodiment of the invention, in relation to accidental sliding of the fly section in the downward direction only, can be a small rope-cam-cleat device or jam-cleat, with a grooved, ribbed face or edge, located just above the rope inside the pulley wheel at the top of the main ladder section. The pulley shaft may be mounted with a spring such that the spring pulls the rope into the jam-cleat or cam-cleat when force on the rope is released. When force is applied to the rope, the spring compresses and the rope is pulled away from the jam-cleat or cam-cleat.

A spring in this pulley-plus-jam-cleat is not actually required because the rope has some elasticity. If the rope is accidentally released the rope jumps upward and slightly outward at the pulley wheel and can be grabbed by the ribbed surface of the jam-cleat, thereby jamming and stopping or slowing the rope. This does not keep the fly section from sliding upward but it is a very low cost way of adding an emergency brake for the downward direction. A unique aspect is how the cam grabs the rope as it jumps upward when the rope is accidentally released.

The most common extension ladder has the rope connected to (looped around) the bottom rung of the fly section. This is why the brake will almost always be attached to the rail of the fly section. There are some ladders that have a rope and double pulley system attached to the right side of the ladder to keep the rope out of the way. The brake assembly can connect to either the top pulley, attached to the base section, or the bottom pulley, attached to the fly section.

Many other renditions of this invention can be made. However, any system that prevents or minimizes the accidental sliding, releasing or lowering of a fly or telescoping extension section of a ladder relative to the main section when force is no longer applied to the extension rope and can brake the two sections to each other at any point in their travel would fit within the scope and spirit of the invention.

1. A ladder extension braking system, for use on extension ladders with an adjustment rope for adjusting the extension, comprising:
(a) a main ladder section having a foot in a downward direction and a top in an upward direction;
(b) an extension ladder section slidably engaged to the main ladder section to allow sliding relative to the main ladder section to extend upwardly above the top of the main ladder section when an adjustment rope is pulled;
(c) a brake base;
(d) coupled to the brake base, a downward brake, biased by a downward brake spring into engaged position that restrains the extension ladder section against downward movement relative to the main ladder section; and
(e) a downward brake retractor, activated to overcome the bias of the downward brake spring by tension applied to the adjustment rope, thereby releasing the brake and allowing the extension ladder section to slide relative to the main ladder section.

2. The ladder extension braking system of claim 1 where the brake base is mounted on the extension ladder section.

3. The ladder extension braking system of claim 2 where the brake retractor is coupled to the adjustment rope such that, when tension is applied to the rope, the brake is retracted.

4. The ladder extension braking system of claim 1 where the brake base is mounted on the main ladder section.

5. The ladder extension braking system of claim 4 where the brake retractor is coupled to a pulley at the top of the main ladder section which pulley moves downwardly relative to the main ladder section when tension is applied to the adjustment rope, thereby retracting the brake.

6. The ladder extension braking system of claim 4 where the brake base is coupled to a pulley at the top of the main ladder section around which the adjustment rope runs, and the brake acts on the adjustment rope to restrain the extension ladder section against downward movement relative to the main ladder section, and the brake retractor releases the adjustment rope when tension is applied to the adjustment rope.

7. A ladder extension braking system, for use on extension ladders with an adjustment rope for adjusting the extension, where the brake works at any adjustment of the extension, comprising:
(a) a main ladder section having a foot in a downward direction and a top in an upward direction;
(b) an extension ladder section slidably engaged to the main ladder section to allow sliding relative to the main ladder section to extend upwardly above the top of the main ladder section when an adjustment rope is pulled;
(c) a brake base;
(d) coupled to the brake base, an upward brake, biased by an upward brake spring into engaged position that restrains the extension ladder section against upward movement relative to the main ladder section at any relative position between the main ladder section and the extension ladder section; and
(e) an upward brake retractor, activated to overcome the bias of the upward brake spring by tension applied to the adjustment rope, thereby releasing the brake and allowing the extension ladder section to slide relative to the main ladder section.

8. The ladder extension braking system of claim 7 where the brake base is mounted on the extension ladder section.

9. The ladder extension braking system of claim 8 where the brake retractor is coupled to the adjustment rope such that, when tension is applied to the rope, the brake is retracted.

10. The ladder extension braking system of claim 7 where the brake base is mounted on the main ladder section.

11. The ladder extension braking system of claim 10 where the brake retractor is coupled to a pulley at the top of the main ladder section which pulley moves downwardly relative to the main ladder section when tension is applied to the adjustment rope, thereby retracting the brake.

12. A ladder extension braking system, for use on extension ladders with an adjustment rope for adjusting the extension, comprising:
(a) a main ladder section having a foot in a downward direction and a top in an upward direction;
(b) an extension ladder section slidably engaged to the main ladder section to allow sliding relative to the main ladder section to extend upwardly above the top of the main ladder section when an adjustment rope is pulled;
(c) a brake base;
(d) coupled to the brake base, an upward brake, biased by an upward brake spring into engaged position that restrains the extension ladder section against upward movement relative to the main ladder section;
(e) an upward brake retractor, activated to overcome the bias of the upward brake spring by tension applied to the adjustment rope, thereby releasing the brake and allowing the extension ladder section to slide relative to the main ladder section;
(f) coupled to the brake base, a downward brake, biased by a downward brake spring into engaged position that restrains the extension ladder section against downward movement relative to the main ladder section; and
(g) a downward brake retractor, activated to overcome the bias of the downward brake spring by tension applied to the adjustment rope, thereby releasing the brake and allowing the extension ladder section to slide relative to the main ladder section.

13. The ladder extension braking system of claim 12 wherein the downward brake retractor and the upward brake retractor are combined in a single structure.

14. The ladder extension braking system of claim 12 wherein the downward brake spring and the upward brake spring are combined in a single spring.

15. The ladder extension braking system of claim 12 wherein the downward brake and the upward brake are combined in a single structure.

16. The ladder extension braking system of claim 12 where the brake base is mounted on the extension ladder section.

17. The ladder extension braking system of claim 16 where the brake retractor is coupled to the adjustment rope such that, when tension is applied to the rope, the brake is retracted.

18. The ladder extension braking system of claim 12 where the brake base is mounted on the main ladder section.

19. The ladder extension braking system of claim 18 where the brake retractor is coupled to a pulley at the top of the main ladder section which pulley moves downwardly relative to the main ladder section when tension is applied to the adjustment rope, thereby retracting the brake.
